(19) United States
(12) Patent Application Publication
(10) Pub. No.: US 2003/0208953 A1
(43) Pub. Date: Nov. 13, 2003

(54) Biodegradable tree shelter

(76) Inventor: Carter Benson McCamy, Adamstown, MD (US)

Correspondence Address: NIXON & VANDERHYE, PC, 1100 N GLEBE ROAD, 8TH FLOOR, ARLINGTON, VA, 22201-4714, US

(21) Appl. No.: 10/434,115

(22) Filed: May 9, 2003

Related U.S. Application Data
(60) Provisional application No. 60/379,059, filed on May 10, 2002.

(51) Int. Cl. A01G 13/02

(52) U.S. Cl. 47/23.2

(57) ABSTRACT

A tree shelter includes two semi-cylindrical cages having complementary coupling devices that secure the cages to each other into a cylindrical configuration. The cages are formed of a biodegradable material. Additives may be included in the material for added functionality, including a bittering agent, a deer repellant and/or a fertilizer. The tree shelter also may include a bird guard that prevents birds from entering the shelter. The shelter is easily and inexpensively manufactured and is easy to install in the field.

### CROSS-REFERENCES TO RELATED APPLICATIONS

This application claims the benefit of U.S. Provisional Patent Application Serial No. 60/379,059, filed May 10, 2002, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The present invention relates generally to landscaping apparatus and, more particularly, to a tree shelter formed of biodegradable materials for protecting newly planted trees.

Existing plant protectors are used to protect-young trees and other types of plants from foraging animals, such as rabbits, rodents and deer. Rubbing by deer has become particularly problematic because of the dramatic increase in deer population in urbanized areas.

Conventionally, tree shelters formed of hydrocarbon-based plastic are placed around the base of a newly planted tree to serve as protection against for aging and rubbing. Hydrocarbon-based plastics, however, remain in the environment as inert, man-made products. Because the conventional shelters are not biodegradable, removal of the structure is required after the tree is established. As the tree grows, girdling of the trunk by a plastic tree shelter may prevent healthy growth of the tree.

Another drawback of existing tree shelters is that they tend to trap birds. Birds commonly enter the shelter searching for insects and are unable to get out. Nets added to the tops of shelters purportedly to address this problem typically fail after the tree begins to grow.

### BRIEF SUMMARY OF THE INVENTION

It would thus be desirable to develop a tree shelter formed of a readily biodegradable material that can be easily installed. It would also be desirable to include structure for preventing birds from entering the shelter that could function reliably throughout the useful life of the shelter. Still further, it would be desirable to form a tree shelter using a process and materials suitable for incorporating additives therein for additional functionality.

In an exemplary embodiment of the invention, a tree shelter is made up of two semi-cylindrical cages. The cages include complementary coupling devices that secure the cages to each other into a cylindrical configuration. The cages are formed of a biodegradable material. The biodegradable material is preferably a starch-based plastic without hydrocarbon-based materials. In one embodiment, the biodegradable material comprises a blend of biodegradable thermoplastic aliphatic polyester, wheat starch and wheat protein. More generally, each of the cages is preferably molded from plastics made of renewable resources.

The cages are formed of the biodegradable material mixed with at least one additive, including one or more of a bittering agent such as denatonium benzoate, a deer repellent such as one made from putrescent egg, and a fertilizer. The combination of materials can be tailored for a specific application or environment.

Each of the cages preferably additionally includes a plurality of radially inwardly extending flexible fingers. The flexible fingers may be formed integral with the cages.

In one arrangement, the cages include a grid structure having openings with respective areas between 0.25-0.75 in², and are preferably about 0.85″×0.5″. With respect to the coupling devices, each of the cages may include at least one male coupling section on one side thereof and at least one corresponding female coupling section on an opposite side thereof. The coupling devices are preferably formed integral with the cages. In one embodiment, the coupling devices comprise complementary snap connectors.

In another exemplary embodiment of the invention, a tree shelter kit includes a plurality of semi-cylindrical cages. Each of the cages includes at least one coupling device engageable with a complementary coupling device of another of the cages for securing two cages to each other into a cylindrical configuration. Each of the cages is formed of a biodegradable material.

In still another exemplary embodiment of the invention, a method of manufacturing a component of tree shelter kit includes the step of molding a plurality of semi-cylindrical cages using a biodegradable material, which molding step includes forming at least one coupling device engageable with a complementary coupling device of another of the cages for securing two cages to each other into a cylindrical configuration.

### BRIEF DESCRIPTION OF THE DRAWINGS

These and other aspects and advantages of the present invention will be described in detail with reference to the accompanying drawings, in which:

FIG. 1 is a perspective view of the tree shelter according to the present invention;

FIG. 2 is a cross-sectional view along the line A-A in FIG. 1;

FIG. 3 is a detailed perspective view of a top end of an assembled tree shelter; and

FIG. 4 is an end view of an assembled tree shelter.

### DETAILED DESCRIPTION OF THE INVENTION

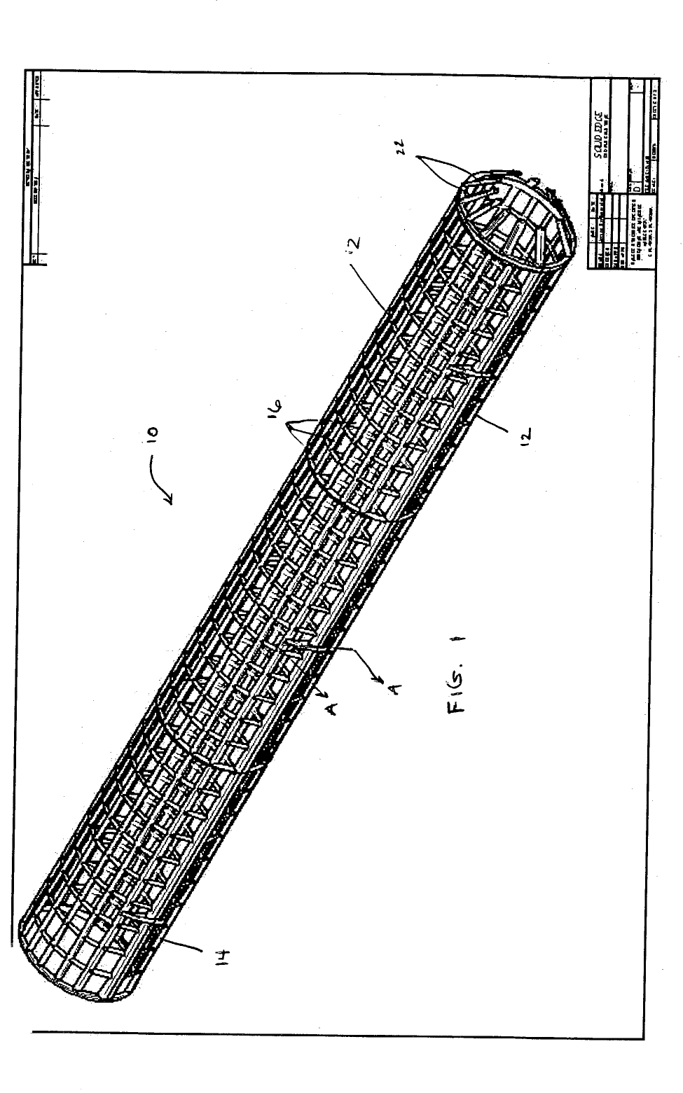

FIG. 1 is a perspective view of an assembled tree shelter 10 according to the present invention. The tree shelter 10 is formed of two semi-cylindrical halves 12 that are secured to each other in facing relation via one or more suitably configured coupling devices 14. When coupled as shown in FIG. 1, the halves 12 together define a cylindrical configuration. The semi-cylindrical halves 12 are generally formed in an open grid configuration as shown, defining semi-cylindrical “cages.” By utilizing an open grid construction, in addition to reducing an amount of materials used, the tree shelter 10 allows air to circulate around the tree, minimizing potential for diseases associated with moisture. Additionally, lateral growth of the tree is facilitated with the open grid. Preferably, the grid structure includes openings 16 having respective areas between 0.25-0.75 in². In one preferred embodiment, the openings 16 are about 0.85″×0.5″.

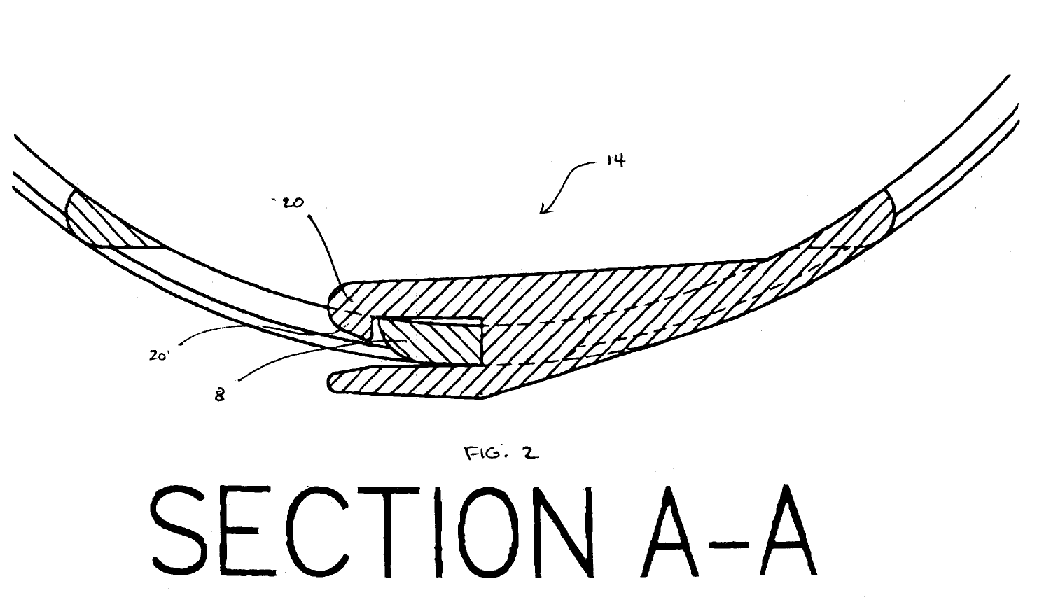

FIG. 2 is a cross-sectional view along line A-A in FIG. 1. The coupling devices shown in FIGS. 1 and 2 are merely exemplary, as many alternative constructions may be suitable. A snap type coupling device 14 as shown in FIG. 2 is preferable to facilitate manufacture of the shelter 10 and installation in the field. As shown, the coupling device 14 includes a male coupling section 18 on one side of each of the semi-cylindrical cages 12 and a corresponding female coupling section 20 on an opposite side thereof. In this manner, identical semi-cylindrical sections 12 can be readily secured to each other in a facing orientation to thereby form the cylindrical configuration of the assembled product (see, for example, FIG. 1). With continued reference to FIG. 2, the female coupling section 20 may include at least one side with a shaped engaging pawl 20′ for securing the male coupling section 18 therein. Any number of coupling devices may be formed along the length of the shelter 10, but it is preferable to include a minimum of two coupling devices 14 per 36″ in length.

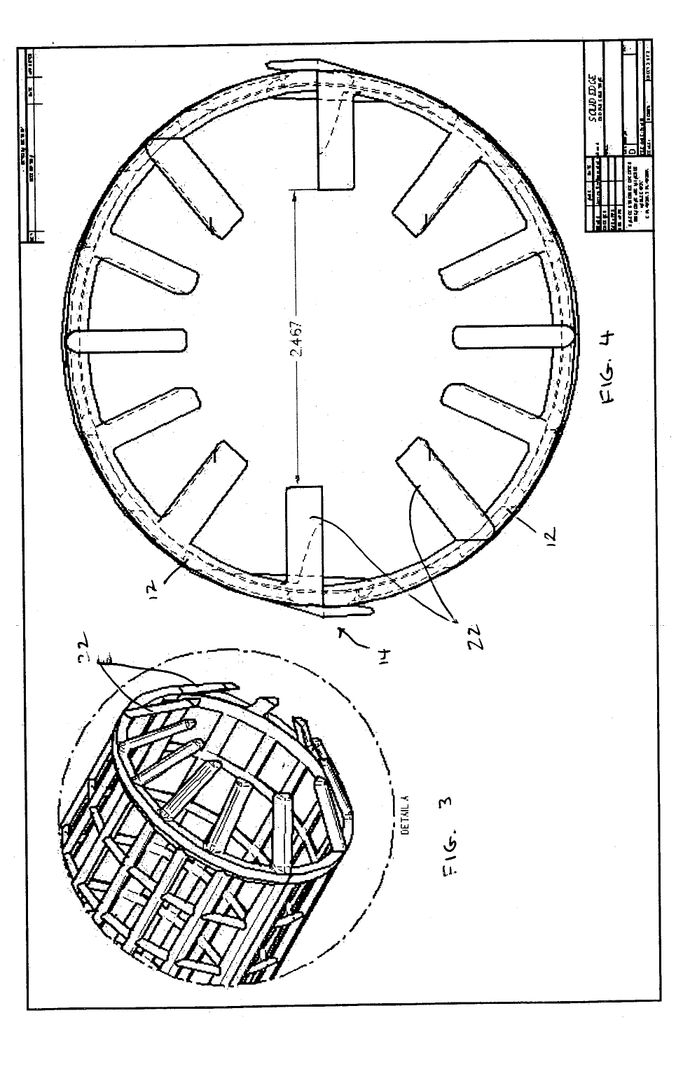

With reference to FIGS. 3 and 4, each of the cages 12 includes a plurality of circumferentially spaced radially inwardly extending flexible fingers 22. As shown in FIG. 3, the fingers 22 are preferably angled inward and upward relative to the circular end of the assembled tree shelter 10. Preferably, the fingers 22 are formed integral with the cages 12. In use, the fingers 22 serve as a bird guard that prevents birds from entering the tree shelter 10. Since the fingers 22 are preferably formed integral with the cages 12, the fingers 22 better maintain their functionality even as the tree grows.

The tree shelter 10 of the present invention is preferably molded using a biodegradable material such as a starch-based plastic. It is preferable to use a moldable biodegradable material in order to support additives. Of course, other biodegradable materials may be suitable, and the invention is not necessarily meant to be limited to the exemplary material described. Preferably, however, the biodegradable material is without hydrocarbon-based materials and is made from renewable resources, and thus there is no dependency on limited oil supplies. Degradation of the finished product should occur as a result of microbial action, as typically would occur when biodegradable materials are subject to contact with soils. One suitable material is a blend of biodegradable thermoplastic aliphatic polyester, wheat starch and wheat protein. The respective compositions of these materials can be suitably adjusted via experimentation.

A conventional molding process is suitable for forming the structure of the tree shelter 10 of the present invention. Typically, a steel mold is made from two halves. The material prior to the molding process may be in bead form or the like, which beads are then heated to create an injectable liquid. Additives can be put into the mix prior to or during heating. The additives may include a bittering agent such as denatonium benzoate, a deer repellant such as Deer-Off™, which is a commercially available deer repellant made from putrescent egg, and/or a fertilizer additive such as a granular fertilizer. The percentage of additives can be adjusted to suit a user's needs. After mixing one or more additives if desired, the heated liquid is injected into the mold, and the molded product cools and is removed from the mold.

To install the tree shelter 10, two of the semi-cylindrical cages 12 are positioned in facing relation on opposite sides of a newly planted tree. The semi-cylindrical cages 12 are identical, and thus in facing relation, the respective male and female coupling devices 18, 20 are properly aligned. The semi-cylindrical cages 12 can be readily snapped together or otherwise connected, and landscape staples, for example, six inch landscape staples, can be used to hold the bottom firm to the ground.

With the structure of the present invention, a functional tree shelter utilizes biodegradable materials and may include additives for added functionality. Additionally, the tree shelter of the invention includes a bird guard that prevents birds from entering the shelter. The coupling device is preferably molded with the semi-cylindrical cages, thereby facilitating manufacture of the product as well as installation in the field.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A tree shelter comprising two semi-cylindrical cages, the cages including complementary coupling devices that secure the cages to each other into a cylindrical configuration, wherein the cages are formed of a biodegradable material.

2. A tree shelter according to claim 1, wherein the biodegradable material is a starch-based plastic.

3. A tree shelter according to claim 1, wherein the biodegradable material is without hydrocarbon-based material.

4. A tree shelter according to claim 1, wherein the biodegradable material comprises a blend of biodegradable thermoplastic aliphatic polyester wheat starch and wheat protein.

5. A tree shelter according to claim 1, wherein each of the cages is molded from plastics made of renewable resources.

6. A tree shelter according to claim 1, wherein the cages are formed of the biodegradable material mixed with at least one additive.

7. A tree shelter according to claim 6, wherein the at least one additive comprises a bittering agent.

8. A tree shelter according to claim 7, wherein the bittering agent is denatonium benzoate.

9. A tree shelter according to claim 6, wherein the at least one additive comprises a deer repellent.

10. A tree shelter according to claim 9, wherein the deer repellent is made from putrescent egg.

11. A tree shelter according to claim 6, wherein the at least one additive comprises a fertilizer.

12. A tree shelter according to claim 6, wherein the at least one additive comprises a bittering agent, a deer repellent, and a fertilizer.

13. A tree shelter according to claim 1, wherein each of the cages comprises a plurality of radially inwardly extending flexible fingers.

14. A tree shelter according to claim 13, wherein the flexible fingers are integral with the cages.

15. A tree shelter according to claim 1, wherein the cages comprise a grid structure including openings having respective areas between 0.25-0.75 in².

16. A tree shelter according to claim 15, wherein the openings are about 0.85 in×0.5 in.

17. A tree shelter according to claim 1, wherein each of the cages comprises at least one male coupling section on one side thereof and at least one corresponding female coupling section on an opposite side thereof.

18. A tree shelter according to claim 1, wherein the coupling devices are integral with the cages.

19. A tree shelter according to claim 1, wherein the coupling devices comprise complementary snap connectors.

20. A tree shelter kit including a plurality of semi-cylindrical cages, each of the cages including at least one coupling device engageable with a complementary coupling device of another of the cages for securing two cages to each other into a cylindrical configuration, wherein each of the cages is formed of a biodegradable material.

21. A method of manufacturing a component of tree shelter kit, the method comprising molding a plurality of semi-cylindrical cages using a biodegradable material, wherein the molding step comprises forming at least one coupling device engageable with a complementary coupling device of another of the cages for securing two cages to each other into a cylindrical configuration.
